(19) United States
(12) Patent Application Publication
(10) Pub. No.: US 2026/0170746 A1
(43) Pub. Date: Jun. 18, 2026

(54) HARDWARE APPARATUS FOR GENERATING 3-DIMENSIONAL CONTENT, GENERATING METHOD AND HARDWARE APPARATUS FOR PHYSICALLY-BASED RENDERING TEXTURE MAP

(71) Applicant: POSTECH RESEARCH AND BUSINESS DEVELOPMENT FOUNDATION, Pohang-si (KR)

(72) Inventors: Tae Hyun OH, Daejeon (KR); You Wang KIM, Pohang-si (KR); Gerard PONS MOLL, Tübingen (KR)

(21) Appl. No.: 19/416,428

(22) Filed: Dec. 11, 2025

(30) Foreign Application Priority Data
Dec. 13, 2024 (KR) 10-2024-0186435
Dec. 4, 2025 (KR) 10-2025-0190370

(51) Int. Cl. G06T 15/04; G06T 7/00; G06T 15/20

(52) U.S. Cl. CPC G06T 15/04; G06T 7/0002; G06T 15/20; G06T 2207/20081; G06T 2207/20084; G06T 2207/30168

(57) ABSTRACT

A hardware apparatus for generating 3D content includes a storage device storing a 3D (dimension) authoring tool; and a processor generating 3D content using at least one 3D asset using the 3D authoring tool. The at least one 3D asset is generated by mapping a PBR (Physically-Based Rendering) texture map to a specific mesh. The texture map is generated by inputting sampled noise into a texture map generation model.

### CROSS REFERENCE TO RELATED APPLICATIONS

The present application claims the benefit of and priority to Korean Patent Application No. 10-2024-0186435, filed Dec. 13, 2024, and to Korean Patent Application No. 10-2025-0190370, filed Dec. 4, 2025, the entire contents of all of which are incorporated herein by reference for all purposes.

### BACKGROUND

### Technical Field

The present disclosure relates to a technique for generating texture maps for text-based three-dimensional meshes.

### Description of the Related Art

Recently, there has been an increasing demand for large-scale production of realistic and diverse 3D (dimension) virtual objects and human avatars in industrial fields such as movies, games, metaverse, and VR (Virtual Reality)/AR (Augmented Reality).

Traditionally, texture maps of 3D content have been created by graphic designers manually designing and coloring them. This approach is time-consuming and requires enormous manpower and cost when processing large quantities of objects.

The description of the related art should not be assumed to be prior art merely because it is mentioned in or associated with this section. The description of the related art includes information that describes one or more aspects of the subject technology, and the description in this section does not limit the invention.

### SUMMARY

In one or more aspects of the present disclosure, a hardware apparatus for generating 3D content includes a storage device storing a 3D (dimension) authoring tool; and a processor generating 3D content using at least one 3D asset using the 3D authoring tool. The at least one 3D asset is generated by mapping a PBR (Physically-Based Rendering) texture map to a specific mesh. The texture map is generated by inputting sampled noise into a texture map generation model.

In one or more aspects of the present disclosure, a hardware apparatus for generating a textured mesh includes an interface device receiving a selection command for a specific mesh, a storage device storing a texture map generation model trained to generate a texture map for the specific mesh, and a processor generating a PBR (Physically-Based Rendering) texture map for the specific mesh by inputting sampled noise into the texture map generation model and mapping the PBR texture map to the specific mesh. The texture map generation model is trained based on SDS (Score-Distillation Sampling) loss, which is calculated by providing multiple 2D images and a text prompt describing the mesh into a text-to-image diffusion model during the training process.

Additional features, advantages, and aspects of the present disclosure are set forth in part in the description that follows and in part will become apparent from the present disclosure or may be learned by practice of the inventive concepts provided herein. Other features, advantages, and aspects of the present disclosure may be realized and attained by the descriptions provided in the present disclosure, or derivable therefrom, and the claims hereof as well as the drawings. It is intended that all such features, advantages, and aspects be included within this description, be within the scope of the present disclosure, and be protected by the following claims. Nothing in this section should be taken as a limitation on those claims. Further aspects and advantages are discussed below in conjunction with embodiments of the present disclosure.

It is to be understood that both the foregoing description and the following description of the present disclosure are examples, and are intended to provide further explanation of the disclosure as claimed.

### BRIEF DESCRIPTION OF THE DRAWINGS

The accompanying drawings, which are included to provide a further understanding of the present disclosure, are incorporated in and constitute a part of this present disclosure, illustrate aspects and embodiments of the present disclosure, and together with the description serve to explain principles and examples of the disclosure. In the drawings:

FIG. 1 illustrates an example of a system for generating PBR texture maps.

FIG. 2 illustrates an example of a pipeline for generating PBR texture maps.

FIGS. 3A-3C show textured meshes generated by the proposed model and conventional models.

FIGS. 4A-4B show textured meshes generated by the proposed model and conventional models.

FIGS. 5A-5D show variations of texture maps generated using the proposed model using graphic tools.

FIG. 6 illustrates an example of a hardware apparatus that generates texture maps using a texture map generation model.

FIG. 7 illustrates an example of a hardware apparatus for generating 3D content.

Throughout the drawings and the detailed description, unless otherwise described, the same drawing reference numerals should be understood to refer to the same elements, features, and structures. The sizes of regions and elements, and depiction thereof may be exaggerated for clarity, illustration, and/or convenience.

### DETAILED DESCRIPTION

The following detailed description is provided to assist the reader in gaining a comprehensive understanding of the methods, apparatuses, and/or systems described herein. Accordingly, various changes, modifications, and equivalents of the systems, apparatuses and/or methods described herein will be understood by those of ordinary skill in the art.

Moreover, descriptions of well-known functions and constructions may be omitted for increased clarity and conciseness. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the embodiments described with reference to the accompanying drawings. The present disclosure may, however, be embodied in different forms and should not be construed as limited to the embodiments set forth herein. Rather, these embodiments are examples and are provided so that this disclosure may be thorough and complete to assist those skilled in the art to understand the inventive concepts without limiting the protected scope of the present disclosure.

Shapes, dimensions (e.g., sizes, lengths, locations, and areas), proportions, ratios, numbers, the number of elements, and the like disclosed herein, including those illustrated in the drawings, are merely examples, and thus, the present disclosure is not limited to the illustrated details. It is, however, noted that the relative dimensions of the components illustrated in the drawings are part of the present disclosure.

When the term “comprise,” “have,” “include,” “contain,” “constitute,” “made of,” “formed of,” “composed of,” or the like is used with respect to one or more elements (e.g., components, structures, groups, circuits, networks, members, parts, areas, portions, integers, steps, operations, and/or the like), one or more other elements may be added unless a term such as “only” or the like is used. The terms used in the present disclosure are merely used in order to describe particular example embodiments, and are not intended to limit the scope of the present disclosure. The terms of a singular form may include plural forms unless the context clearly indicates otherwise. For example, an element may be one or more elements. An element may include a plurality of elements. The word “exemplary” is used to mean serving as an example or illustration. Embodiments are example embodiments. Aspects are example aspects. In one or more implementations, “embodiments,” “examples,” “aspects,” and the like should not be construed to be preferred or advantageous over other implementations. An embodiment, an example, an example embodiment, an aspect, or the like may refer to one or more embodiments, one or more examples, one or more example embodiments, one or more aspects, or the like, unless stated otherwise. Further, the term “may” encompasses all the meanings of the term “can.”

In one or more aspects, unless explicitly stated otherwise, an element, feature, or corresponding information (e.g., a level, range, dimension, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

When a positional relationship between two elements (e.g., components, structures, groups, circuits, networks, members, parts, areas, portions, and/or the like) are described using any of the terms such as “adjacent to,” “beside,” “next to,” and/or the like indicating a position or location, one or more other elements may be located between the two elements unless a more limiting term, such as “immediate(ly),” “direct(ly),” or “close(ly),” is used. Furthermore, the spatially relative terms such as the foregoing terms as well as other terms such as “column,” “row,” “vertical,” “horizontal,” “diagonal,” and the like refer to an arbitrary frame of reference.

In describing a temporal relationship, when the temporal order is described as, for example, “after,” “following,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” and the like may be used herein to describe various elements (e.g., components, structures, groups, circuits, networks, members, parts, areas, portions, and/or the like), these elements should not be limited by these terms, for example, to any particular order, precedence, or number of elements. These terms are used only to distinguish one element from another. For example, a first element may denote a second element, and, similarly, a second element may denote a first element, without departing from the scope of the present disclosure. Furthermore, the first element, the second element, and the like may be arbitrarily named according to the convenience of those skilled in the art without departing from the scope of the present disclosure. For clarity, the functions or structures of these elements (e.g., the first element, the second element, and the like) are not limited by ordinal numbers or the names in front of the elements. Further, a first element may include one or more first elements. Similarly, a second element or the like may include one or more second elements or the like.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

The expression that an element (e.g., component, structure, group, circuit, network, member, part, area, portion, and/or the like) “is engaged” with another element may be understood, for example, as that the element may be either directly or indirectly engaged with the another element. The term “is engaged” or similar expressions may refer to a term such as “is connected,” “is coupled,” “is combined,” “is linked,” “is provided,” “interacts,” or the like. The engagement may involve one or more intervening elements disposed or interposed between the element and the another element, unless otherwise specified.

The terms such as a “line” or “direction” should not be interpreted only based on a geometrical relationship in which the respective lines or directions are parallel, perpendicular, diagonal, or slanted with respect to each other, and may be meant as lines or directions having wider directivities within the range within which the components of the present disclosure may operate functionally.

The term “at least one” should be understood as including any and all combinations of one or more of the associated listed items. For example, each of the phrases “at least one of a first item, a second item, or a third item” and “at least one of a first item, a second item, and a third item” may represent (i) a combination of items provided by two or more of the first item, the second item, and the third item or (ii) only one of the first item, the second item, or the third item. Further, at least one of a plurality of elements can represent (i) one element of the plurality of elements, (ii) some elements of the plurality of elements, or (iii) all elements of the plurality of elements. Further, “at least some,” “at least some portions,” “at least some parts,” “at least a portion,” “at least one or more portions,” “at least a part,” “at least one or more parts,” “at least some elements,” “one or more,” or the like of a plurality of elements can represent (i) one element of the plurality of elements, (ii) a portion (or a part) of the plurality of elements, (iii) one or more portions (or parts) of the plurality of elements, (iv) multiple elements of the plurality of elements, or (v) all of the plurality of elements. Moreover, “at least some,” “at least some portions,” “at least some parts,” “at least a portion,” “at least one or more portions,” “at least a part,” “at least one or more parts,” or the like of an element can represent (i) a portion (or a part) of the element, (ii) one or more portions (or parts) of the element, or (iii) the element, or all portions of the element.

The expression of a first element, a second elements “and/or” a third element should be understood as one of the first, second and third elements or as any or all combinations of the first, second and third elements. By way of example, A, B and/or C may refer to only A; only B; only C; any of A, B, and C (e.g., A, B, or C); some combination of A, B, and C (e.g., A and B; A and C; or B and C); or all of A, B, and C. Furthermore, an expression “A/B” may be understood as A and/or B. For example, an expression “A/B” may refer to only A; only B; A or B; or A and B.

In one or more aspects, the terms “between” and “among” may be used interchangeably simply for convenience unless stated otherwise. For example, an expression “between a plurality of elements” may be understood as among a plurality of elements. In another example, an expression “among a plurality of elements” may be understood as between a plurality of elements. In one or more examples, the number of elements may be two. In one or more examples, the number of elements may be more than two. Furthermore, when an element is referred to as being “between” at least two elements, the element may be the only element between the at least two elements, or one or more intervening elements may also be present.

In one or more aspects, the phrases “each other” and “one another” may be used interchangeably simply for convenience unless stated otherwise. For example, an expression “different from each other” may be understood as being different from one another. In another example, an expression “different from one another” may be understood as being different from each other. In one or more examples, the number of elements involved in the foregoing expression may be two. In one or more examples, the number of elements involved in the foregoing expression may be more than two.

In one or more aspects, the phrases “one or more among” and “one or more of” may be used interchangeably simply for convenience unless stated otherwise.

The term “or” means “inclusive or” rather than “exclusive or.” That is, unless otherwise stated or clear from the context, the expression that “x uses a or b” means any one of natural inclusive permutations. For example, “a or b” may mean “a,” “b,” or “a and b.” For example, “a, b or c” may mean “a,” “b,” “c,” “a and b,” “b and c,” “a and c,” or “a, b and c.”

A phrase “substantially the same” may indicate a degree of being considered as being equivalent to each other taking into account minute differences due to errors in the manufacturing or operating process.

Features of various embodiments of the present disclosure may be partially or entirely coupled to or combined with each other, may be technically associated with each other, and may be variously operated, linked or driven together in various ways. Embodiments of the present disclosure may be implemented or carried out independently of each other or may be implemented or carried out together in a co-dependent or related relationship. In one or more aspects, the components of each apparatus and device according to various embodiments of the present disclosure are operatively coupled and configured.

The terms used herein have been selected as being general in the related technical field; however, there may be other terms depending on the development and/or change of technology, convention, preference of technicians, and so on. Therefore, the terms used herein should not be understood as limiting technical ideas, but should be understood as examples of the terms for describing example embodiments.

Further, in a specific case, a term may be arbitrarily selected by an applicant, and in this case, the detailed meaning thereof is described herein. Therefore, the terms used herein should be understood based on not only the name of the terms, but also the meaning of the terms and the content hereof.

In the following description, various example embodiments of the present disclosure are described in more detail with reference to the accompanying drawings. With respect to reference numerals to elements of each of the drawings, the same elements may be illustrated in other drawings, and like reference numerals may refer to like elements unless stated otherwise. The same or similar elements may be denoted by the same reference numerals even though they are depicted in different drawings. In addition, for the convenience of description, a scale and dimension of each of the elements illustrated in the accompanying drawings may be different from an actual scale and dimension, and thus, embodiments of the present disclosure are not limited to a scale and dimension illustrated in the drawings.

Before starting detailed explanations of figures, components that will be described in the specification are distinguished merely according to functions mainly performed by the components. That is, two or more components which will be described later can be integrated into a single component. Furthermore, a single component which will be explained later can be separated into two or more components. Moreover, each component which will be described can additionally perform some or all of a function executed by another component in addition to the main function thereof. Some or all of the main function of each component which will be explained can be carried out by another component. Accordingly, presence/absence of each component which will be described throughout the specification should be functionally interpreted.

The following description is a technique for generating texture maps for meshes of 3D virtual objects.

A mesh is a basic data structure for representing the shape of an object in three-dimensional space. The mesh consists of vertices, edges, and faces that define the appearance of a specific object. Meshes are the basic units of three-dimensional modeling and rendering.

A texture map refers to two-dimensional image data used to express surface characteristics of objects in three-dimensional graphics. The texture map refers to a texture mapped on a two-dimensional UV coordinate system obtained by unfolding the surface of a three-dimensional object.

The UV coordinate system is a coordinate system that represents a three-dimensional mesh surface as a two-dimensional development.

PBR texture maps consist of a basic diffuse map (color, diffuse map), roughness map, metalness map, and normal map (normal vector). PBR texture maps are texture maps for effectively expressing the physical properties of an object's surface.

In the following description, it is explained that an image processing apparatus generates texture maps. An image processing apparatus is a computing device capable of image preprocessing, neural network operations, etc. The image processing apparatus may be implemented in various forms. For example, the image processing apparatus may take the form of a PC, smart device, network server, data processing-dedicated chipset, etc.

The image processing apparatus may generate a texture map for a specific object mesh using a neural network model.

The neural network model may use any one of various architectures. For example, the neural network model may utilize U-Net series architecture, ResNet-based architecture, etc. In a broad sense, the neural network model may be referred to as a CNN (Convolutional Neural Networks)-based model. For convenience of description, the model that generates texture maps is referred to as a texture map generation model.

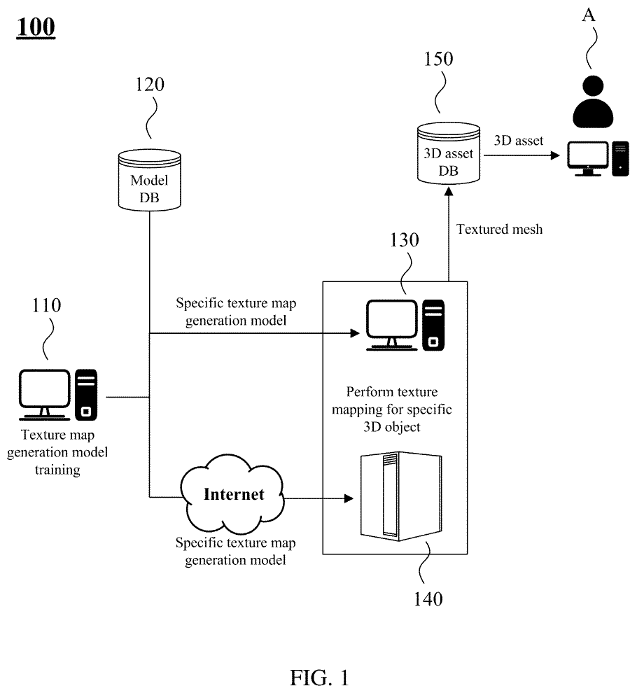

FIG. 1 illustrates an example of a system 100 for generating PBR texture maps. In FIG. 1, the computer terminal 130 and/or server 140 correspond to the image processing apparatus.

The training apparatus 110 is a device that builds a texture map generation model. The training apparatus 110 is a computer device capable of image processing, neural network model operation, and parameter updating. In FIG. 1, the training apparatus 110 is shown in the form of a PC. However, the training apparatus 110 may be any of various forms such as a smart device, server, PC, etc.

The process of building the texture map generation model will be described later.

The training apparatus 110 may store the built texture map generation model in a model database DB, 120. At this time, the training apparatus 110 may build a texture map generation model for each 3D object type.

The computer terminal 130 may receive a specific texture map generation model from the training apparatus 110 or model DB 120 through a wired or wireless network. The computer terminal 130 may generate a PBR texture map for a specific object using the texture map generation model. The computer terminal 130 may perform texture mapping on an untextured mesh using the texture map generation model. The computer terminal 130 may store the texture-mapped textured mesh in a 3D asset DB 150. The computer terminal 130 may generate textured meshes for various objects and store them in the 3D asset DB 150.

The server 140 may receive a specific texture map generation model from the training apparatus 110 or model DB 120 through a wired or wireless network. The server 140 may generate a PBR texture map for a specific object using the texture map generation model. The server 140 may perform texture mapping on an untextured mesh using the texture map generation model. The server 140 may store the texture-mapped textured mesh in the 3D asset DB 150. The server 140 may generate textured meshes for various objects and store them in the 3D asset DB 150.

Later, graphic designer A may receive desired 3D assets from the 3D asset DB 150 through their user terminal. Graphic designer A may produce 3D content using the received 3D assets.

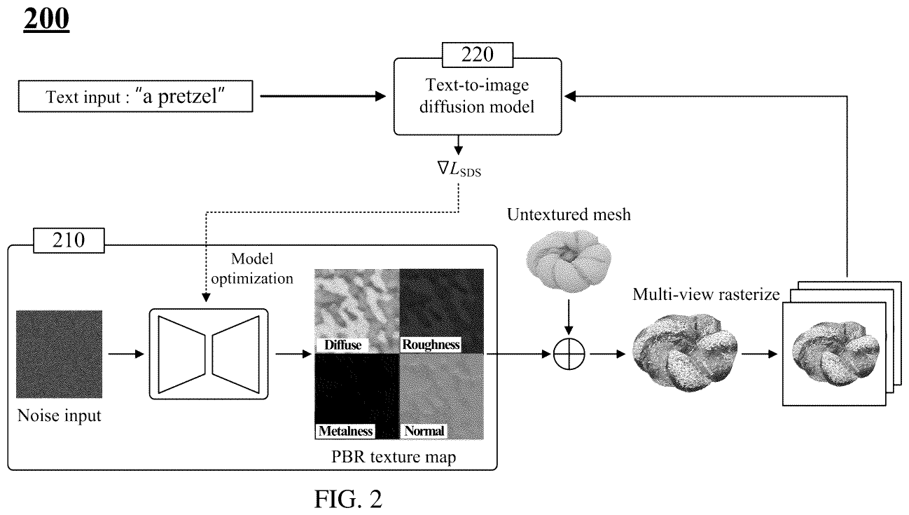

FIG. 2 illustrates an example of a pipeline 200 for generating PBR texture maps. FIG. 2 illustrates a training process of the texture map generation model. The pipeline 200 includes a texture map generation model 210 and a text-to-image diffusion model 220.

The training apparatus performs the training process.

The PBR texture map is for a specific object mesh. Therefore, an untextured mesh must be prepared in advance. FIG. 2 shows a pretzel, which is a type of bread, as an example.

The texture map generation model 210 receives noise and generates a PBR texture map. The texture map generation model 210 directly models each texture channel as an output map of a 2D convolutional network. The PBR texture map consists of a diffuse map, a roughness map, a metalness map, and a normal map. The texture map generation model 210 may calculate maps for each of the four channels by receiving noise. In this case, the texture map generation model 210 may have a structure with separate networks for the four channels internally. Meanwhile, both the roughness map and metalness map are single-channel maps determined by scalar values (in the range 0˜1). Therefore, the roughness map and metalness map may be processed together as a single channel.

The texture map generation model 210 may use any of various types of models. In FIG. 2, the texture map generation model 210 shows a U-Net-based structure model as an example. The U-Net model has an encoder, decoder, and skip connections.

The initial texture map generation model 210 may use a randomly initialized model.

The texture map generation model 210 receives noise. The noise may use randomly sampled random number code z˜ [symbol] (0, 1)∈R^{H×W×3}. H and W represent the height and width of the texture map. The noise z uses a fixed value in the model optimization process.

The training apparatus re-parameterizes pixel-wise PBR parameters of the texture map to the convolutional kernels of the texture map generation model 210 [symbol] through the training process. The result may be expressed by Equation 1 below.

$$[ {K}_{θ}^{d} , {K}_{θ}^{m} , {K}_{θ}^{n} ] = {𝒯}_{θ} ( z ) \qquad [ Equation 1 ]$$

In the above equation,

$${K}_{θ}^{d}$$

represents the color (albedo) map,

$${K}_{θ}^{m}$$

represents the roughness and metalness maps, and

$${K}_{θ}^{n}$$

represents the normal map.

$${K}_{θ}^{d} , {K}_{θ}^{n} ∈ {R}^{H \times W \times 3} and {K}_{θ}^{m} ∈ {R}^{H \times W \times 2} .$$

Therefore, [symbol] (z)∈R^{H×W×(3+2+3)}.

The quality of the PBR texture map initially output by the texture map generation model 210 may be low. The purpose of the pipeline 200 is not to optimize pixels, but to optimize the convolutional kernel parameters θ of the texture map generation model 210 [symbol] .

The training apparatus maps the PBR texture map output by the texture map generation model 210 to the UV coordinate system of the untextured mesh. The training apparatus generates a textured 3D mesh.

The training apparatus generates 2D images by rendering from multiple viewpoints through differentiable rasterization of the textured 3D mesh. That is, the training apparatus generates 2D images from different viewpoints from one 3D mesh.

In this process, the viewpoints may randomly selected. Complex objects such as people or animals may use a larger number of viewpoints (e.g., N=8), while relatively simple objects may use an appropriate number of viewpoints (e.g., N=4).

The training apparatus may calculate information (gradient) for parameter update of the texture map generation model 210 using a separate text-to-image diffusion model 220. The text-to-image diffusion model 220 uses a pre-trained model. The text-to-image diffusion model 220 is used in a frozen state without being updated in the training process.

Conventional text-to-image diffusion models are models that receive text prompts and generate certain 2D images. The text-to-image diffusion model 220 may use any of various architectures. The text-to-image diffusion model 220 is preferably a diffusion model. For example, the text-to-image diffusion model 220 may use DDPM (denoising diffusion probabilistic models), LDM (Latent Diffusion Model), etc.

The training apparatus inputs an object description (text prompt) for the object to be generated into the text-to-image diffusion model 220. FIG. 2 exemplifies “a pretzel” as the input text.

The text-to-image diffusion model 220 may calculate the loss for parameter update of the texture map generation model 210 by taking the text prompt and the 2D images rendered from the multiple viewpoints as inputs.

The training apparatus may obtain SDS (Score-Distillation Sampling) loss ∇ [symbol] _{SDS} from the text-to-image diffusion model 220 based on the multiple viewpoint 2D images generated through rasterization and the input text.

The SDS loss is described. SDS loss was proposed in an image generation model that generates 3D objects from text through 2D rendering. SDS is a technique for optimizing a three-dimensional scene according to text conditions in a text-to-image diffusion model.

To perform SDS, first, noise is added to the rendered image x=g(θ) to create a noisy image xₜ. At this time, noise ϵ˜ [symbol] (0, I) and noising timestep t˜U(0, 1) are sampled. Initially, the rendered image x may not conform to the object described in the text prompt y. Therefore, the difference between the added noise & and the text-conditionally estimated noise \hat{ϵ}_{φ}(xₜ; y, t) may be large. At this time, a pre-trained text-conditional noise estimator ε_{Φ} may be used to estimate the noise. Here, Φ is a parameter of the diffusion model. Therefore, the optimization problem in that model may be expressed as Equation 2 below.

$${θ}^{*} = arg {min}_{θ} {L}_{diff} ( ϕ , x = g ( θ ) ) \qquad [ Equation 2 ]$$

$${L}_{diff} ( ϕ , x = g ( θ ) ) = \text{?} [ m ( t ) {‖ \text{?} ( {x}_{t} ; y , t ) - ϵ ‖}_{2}^{2} ] \qquad [ Equation 3 ]$$

$$\text{?} \text{indicates text missing or illegible when filed}$$

Therefore, the update gradient for the 3D representation θ may be expressed as Equation 4 below.

$$\text{?} {ℒ}_{SDS} ( ϕ , x ) = \text{?} [ m ( t ) ( \text{?} ( {x}_{t} ; y , t ) - ϵ ) \frac{\partial x}{\partial θ} ] \qquad [ Equation 4 ]$$

$$\text{?} \text{indicates text missing or illegible when filed}$$

Here, m(t) is a weighting function conditioned on the diffusion noise timestep t.

The training apparatus may calculate SDS loss ∇ [symbol] _{SDS} between the multiple viewpoint 2D images generated through rasterization and the input text using the text-to-image diffusion model 220.

First, the rendering process using PBR texture maps is described.

To render the mesh surface, the diffuse

$${k}_{θ}^{d} ∈ {R}^{3} ,$$

roughness

$${k}_{θ}^{r} ∈ R ,$$

metalness

$${k}_{θ}^{m} ∈ R ,$$

and normal direction

$${k}_{θ}^{n} ∈ R$$

of the three-dimensional surface point p may be indexed from the PBR texture map based on UV coordinates. The UV coordinates may use pre-defined coordinates for a given mesh or coordinates generated through unwrapping. Meanwhile, the specularity

$${k}_{θ}^{s} ∈ {R}^{3}$$

is calculated as

$${k}_{θ}^{s} = 0.04 \cdot ( 1 - {k}_{θ}^{m} ) + {k}_{θ}^{m} \cdot {k}_{θ}^{d} .$$

The rendered color L of the mesh surface point p observed from the view direction ω may be calculated as Equation 5 below.

$${L}_{θ} ( p , ω ) = {\int }_{Ω} {L}_{i} ( p , {ω}_{i} ) {f}_{θ} ( p , {ω}_{i} , ω ) ( {ω}_{i} \cdot {n}_{θ} ) d {ω}_{i} \qquad [ Equation 5 ]$$

Here, ωᵢ is incident illumination direction, Ω is a hemisphere around the surface normal n_{θ}, and Lᵢ is incident illumination from the environment map. f_{θ}(p, ωᵢ, ω) is the BRDF (Bidirectional Reflectance Distribution Function) of the material at the 3D surface point p.

When the training apparatus performs rendering for all surface points, the entire textured mesh is generated.

The training process repeatedly performs the same process. In each iteration, (i) map the PBR texture generated by the current T_{θ} to the mesh, (ii) generate multi-view 2D images through differentiable rasterization, (iii) input the 2D images along with the text condition y into the pre-trained diffusion model to calculate SDS loss, (iv) update the parameters θ of T_{θ} according to the SDS loss gradient. The training apparatus updates the parameters of the texture map generation model 210 at each iteration. Since the initial texture map generation model 210 was randomly initialized, the texture map generation model 210 produces noisy PBR texture maps in the initial iteration process.

The training apparatus iteratively updates the texture map generation model 210 T_{θ} using the SDS loss ∇ [symbol] _{SDS}. At this time, the optimization problem of the model may be defined as Equation 6 below.

$${θ}^{*} = {arg min}_{θ} \text{?} [ {‖ \text{?} ( {ℛ}_{t}^{M} ( {K}_{θ}^{d} , \text{?} , {K}_{θ}^{n} ) ; y , t ) - ϵ ‖}_{2}^{2} ] \qquad [ Equation 6 ]$$

$$\text{?} \text{indicates text missing or illegible when filed}$$

Here, Φ is a parameter of the pre-trained text-to-image diffusion model 220.

$${R}_{t}^{M} ( {K}_{θ}^{d} , {K}_{θ}^{rm} , {K}_{θ}^{n} )$$

represents a noisy image produced by the forward diffusion process. In the above equation, the time t-dependent weighting function m (t) is omitted for notation.

The training apparatus generates a 2D image I_{θ} through rasterization of the textured mesh.

The training apparatus inputs the generated 2D image and text prompt into the text-to-image diffusion model 220. The text-to-image diffusion model 220 adds noise according to timestep t in the diffusion process. The noise-added image is I_{θ,t}, and the text condition is y. At this time, the text-to-image diffusion model 220 may calculate predicted noise \hat{ϵ}_{φ}(xₜ; y, t).

The text-to-image diffusion model 220 calculates the predicted noise that must be removed for the given input image to converge to a distribution that satisfies the text prompt condition. That is, the text-to-image diffusion model 220 adds noise to the input image through the forward diffusion process, and the reverse process removes noise. The predicted noise represents the total noise to be removed. SDS loss may be determined according to the difference between the noise added to the input image and the predicted noise. At this time, the training apparatus may calculate the SDS loss ∇ [symbol] _{SDS} in the form of a gradient for parameter update of the texture map generation model 210 as shown in Equation 7 below.

$${∇}_{θ} {ℒ}_{SDS} ( ϕ , {I}_{θ} ) = \text{?} [ ( \text{?} ( {I}_{θ , t} ; y , t ) - ϵ ) \frac{\partial {I}_{θ}}{\partial θ} ] = \text{?} [ \{ \text{?} ( {ℛ}_{t}^{M} ( {K}_{θ}^{d} , \text{?} , {K}_{θ}^{n} ) ; y , t ) - ϵ \} \frac{\partial {I}_{θ}}{\partial θ} ] \qquad [ Equation 7 ]$$

$$\text{?} \text{indicates text missing or illegible when filed}$$

The SDS loss is calculated based on the difference between the noise of the 2D image generated by rasterization in the text-to-image diffusion model 220 and the text-conditionally estimated noise.

As described above, the training apparatus generates multiple viewpoint 2D images for the textured mesh. In this case, the training apparatus may update the parameters of the texture map generation model 210 based on the average or sum of SDS losses for the multiple 2D images.

The training apparatus performs optimization of the texture map generation model 210 while repeatedly performing the process described in FIG. 2. Through this process, the texture map generation model 210 is trained to generate high-quality PBR texture maps.

When training is complete, the texture map generation model 210 generates a PBR texture map for the corresponding 3D object mesh without any other information. That is, in the inference process, the texture map generation model 210 is used.

Meanwhile, the texture map generation model 210 built through the process of FIG. 2 may generate texture maps for a specific type of object (pretzel). For objects with different characteristics, a separate dedicated texture map generation model needs to be built through the process of FIG. 2. Therefore, the training apparatus may build multiple texture map generation models corresponding to 3D object types using the training process of FIG. 2 according to the 3D object type.

Results of building and verifying the performance of the proposed model are described. At this time, the proposed model refers to the texture map generation model trained through the process of FIG. 2.

The proposed model was built using the Objaverse (MDeitke et al., Objaverse: A universe of annotated 3d objects. CVPR, 2023), RenderPeople (https://renderpeople.com/, 2023.), and SMAL (Zuffi et al., 3D menagerie: Modeling the 3D shape and pose of animals, CVPR, 2017) datasets. Also, the performance of the built model was verified using those datasets.

The performance of the proposed model and conventional models was compared. The conventional models compared were Latent-Paint (Metzer et al., Latent-nerf for shape-guided generation of 3d shapes and textures, In IEEE Conference on Computer Vision and Pattern Recognition (CVPR), 2023), Fantasia3D (Chen et al., Fantasia3d: Disentangling geometry and appearance for highquality text-to-3d content creation, In IEEE International Conference on Computer Vision (ICCV), 2023.), Text2Tex (Chen et al., Text2tex: Text-driven texture synthesis via diffusion models. ICCV, 2023.) and TEXTure (Richardson et al., Texture: Text-guided texturing of 3d shapes, ACM Transactions on Graphics (SIGGRAPH), 2023.).

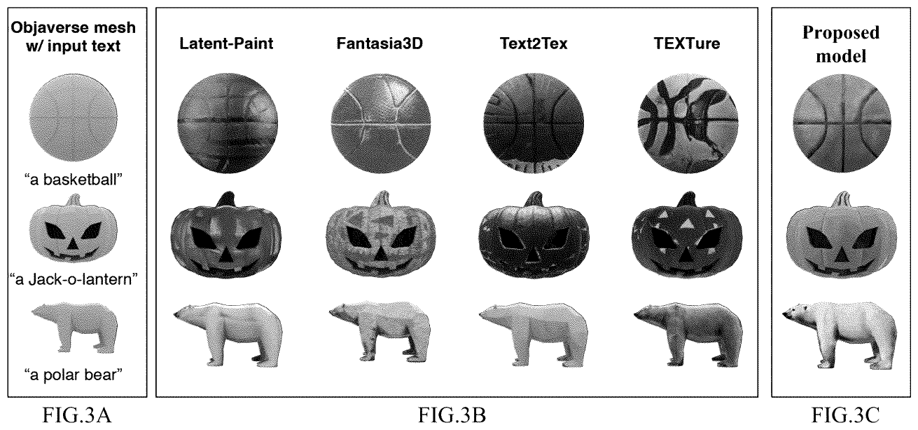

FIGS. 3A-3C show textured meshes generated by the proposed model and conventional models. FIGS. 3A-3C show results of mapping texture maps calculated using the proposed model and conventional models. FIG. 3A shows untextured meshes extracted from the Objaverse dataset. The meshes are “a basketball”, “a Jack-o-lantern” and “a polar bear”. FIG. 3B shows results of generating textured meshes using conventional models. Conventional models mostly generate only RGB-based textures. Looking at the texture-mapped results, it can be seen that the 3D object has a certain color reflected, but the material texture is different from the actual object. FIG. 3C shows results of generating textured meshes using the proposed model. The proposed model generates PBR texture maps and expresses both color and material texture well.

The proposed model synthesizes more vivid, realistic, and consistent textures compared to texture inpainting methods such as Text2Tex and TEXTure. Text2Tex and TEXTure showed problems with multi-view texture inconsistencies and baked lighting effects. Latent-Paint synthesizes blurry textures and also provides only diffuse textures. Fantasia3D trains a coordinate-based MLP (Multilayer Perceptron) to predict per-point PBR materials. In contrast, the proposed model globally parameterizes the entire texture map. The proposed model has a global effect over the entire texture, while Fantasia3D is much more local.

Also, quantitative evaluation was performed on textured meshes generated by the proposed model and conventional models. Table 1 below shows the quantitative evaluation results. The quantitative evaluation used FID (Frechet Inception Distance) and user preference evaluation (User score) as indicators.

TABLE 1

| | Latent- | | | | |
|---|---|---|---|---|---|
| | Paint | Fantasia3D | Text2Tex | TEXTure | Ours |
| FID (↓) | 41.11 | 58.79 | 37.89 | 38.40 | 34.46 |
| User score (↑) | 3.22 | 2.71 | 3.34 | 3.04 | 4.37 |

The proposed model has lower FID scores compared to conventional models. This means that the texture generated by the proposed model is closer to the actual data distribution. The user preference score is the result of 30 evaluators comparing the results from the Objaverse and other datasets. The proposed model showed higher realism scores compared to conventional models.

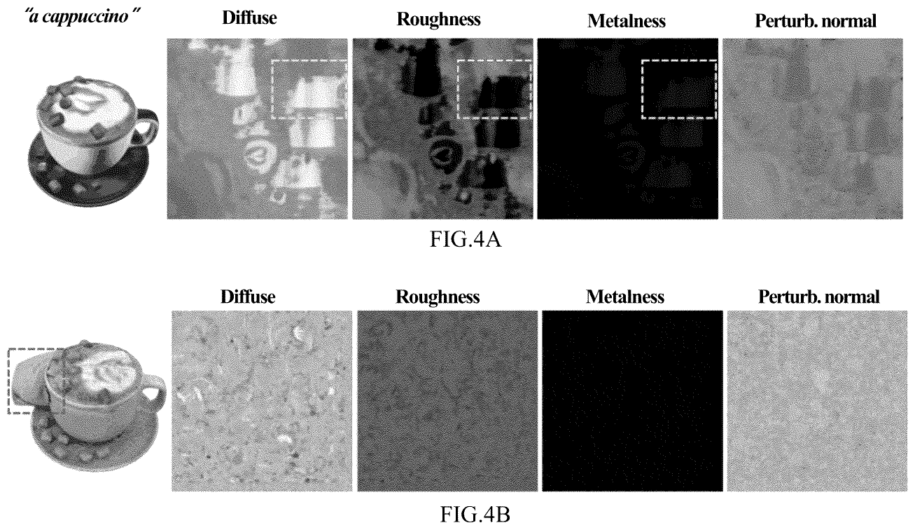

FIGS. 4A-4B show textured meshes generated by the proposed model and conventional models. FIG. 4A shows a textured mesh mapping the texture map generated by the proposed model and each channel map of the PBR texture map. FIG. 4B shows a textured mesh mapping the texture map generated by Fantasia3D for the same object as FIG. 4A and each channel map of the PBR texture map. The texture map of Fantasia3D is overall blurry and lacks high-frequency detail expression. The texture map of Fantasia3D has ambiguous material distinction because the roughness and metalness maps are not properly separated. The mesh mapped with Fantasia3D's texture map showed a monotonous surface unlike the actual object, and errors occurred in some areas (dotted boxes). In contrast, the proposed model has vivid color, pattern, and texture in the texture, and fine expression is clear in the normal map. As a result, it can be seen that the mesh mapped with the texture of the proposed model is much closer to the actual object compared to the result of Fantasia3D.

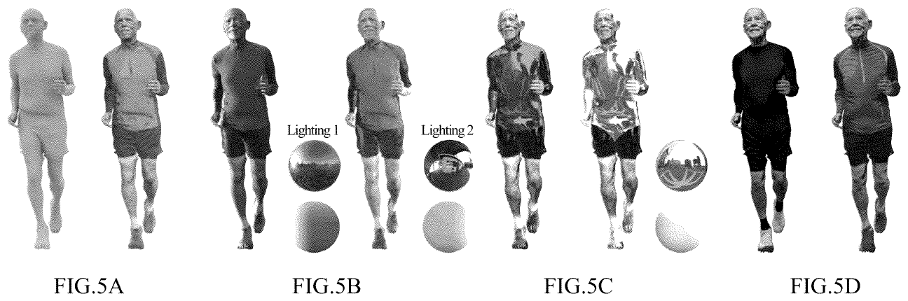

FIGS. 5A-5D show variations of texture maps generated using the proposed model using graphic tools. FIG. 5A show an example of an untextured mesh and a textured mesh mapping the texture map generated by the proposed model. Since the proposed model synthesizes PBR texture maps, operations such as lighting, material, and texture transformation are immediately easy in commercial graphic engines (Blender, Unity, Unreal, etc.). FIG. 5B, FIG. 5C, and FIG. 5D are examples of transforming the original textured mesh of FIG. 5A using Blender. FIG. 5B show an example of relighting by changing HDR (High-Dynamic Range) environmental lighting. FIG. 5C show an example of changing material properties. FIG. 5D show an example of mapping different PBR texture maps to the same mesh. FIGS. 5B-5D indicate that PBR texture maps generated by the proposed model can be immediately applied to various practical applications such as games, movies, metaverse, design, and animatable avatars.

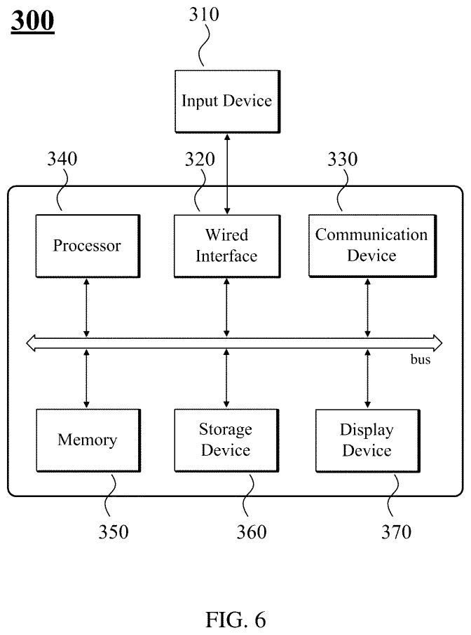

FIG. 6 illustrates an example of a hardware apparatus 300 that generates texture maps using a texture map generation model. The hardware apparatus 300 corresponds to the image processing apparatus described above. The hardware apparatus 300 may take the form of a computer device, smart device, network server, data processing-dedicated chipset, etc.

The hardware apparatus 300 may include an input device 310, wired interface 320, communication device 330, processor 340, memory 350, and storage device 360.

Alternatively, the hardware apparatus 300 may include an input device 310, wired interface 320, communication device 330, processor 340, memory 350, storage device 360, and display device 370.

Each internal component of the hardware apparatus 300 may be connected by a bus. The bus may use a specific bus depending on the type of connected entity. For example, the bus may be any one of AMBA (AHB/AXI/APB), PCIe, SPI (Serial Peripheral Interface), or MIPI (Mobile Industry Processor Interface).

The input device 310 is a device that receives user commands or information.

Also, the input device 310 may be a device that receives necessary data from a physically connected external device or storage device.

The input device 310 may receive a texture map generation model.

The input device 310 may be any of various types of devices. For example, the input device 310 may be at least one of a mouse, keyboard, touch input device, camera, Small Computer System Interface (SCSI) device, Peripheral Component Interconnect (PCI) bus-based device, or ATA Packet Interface (ATAPI) device.

The wired interface 320 is a device component that transfers data transmitted by the input device 310 inside the device. The wired interface 320 may consist of software drivers and hardware.

The wired interface 320 may include a controller corresponding to each input device, a device driver controlling the operation of the controller, and a kernel I/O subsystem that integrally manages input/output control requests of the device driver. The kernel I/O subsystem stores input/output requests from the device driver in a queue and schedules the requests based on request priority or device status.

The wired interface 320 may include interfaces such as PS/2, USB (Universal Serial Bus), Ethernet port, HDMI, MIPI CSI, DisplayPort, Thunderbolt, etc.

The wired interface 320 may transfer the generated PBR texture map to other components inside the device or external objects.

The wired interface 320 may transfer a textured mesh mapping the PBR texture map to other components inside the device or external objects.

The communication device 330 refers to a component that receives and transmits certain information through external wired or wireless networks. The communication device 330 may consist of a circuit including an antenna and a communication module (S/W module, chip, etc.) corresponding to a communication protocol. The communication protocol may be at least one of wired LAN (Ethernet), wireless LAN (IEEE 802.11), mobile communication (LTE, 5G NR, etc.), Bluetooth, NFC, etc.

The communication device 330 may receive a texture map generation model.

The communication device 330 may transmit the generated PBR texture map to external objects.

The communication device 330 may transmit a textured mesh mapping the PBR texture map to external objects.

The processor 340 controls the operation of all components of the hardware apparatus 300. Also, the processor 340 controls the visualization process of simulation data.

The processor 340 may perform operations on at least one application or computer program for executing methods/operations according to various embodiments of the present disclosure.

The processor 340 is a general-purpose processor that executes at least part of a control program installed in the storage device 360 or at least part of a program loaded in the memory 350.

The processor 340 may be implemented as circuitry (e.g., processing circuitry) such as a system on chip (SoC) or integrated circuit (IC).

The processor 340 may include one or more processors. For example, the processor 340 may include a combination of one or more processors such as a central processing unit (CPU), microprocessor unit (MPU), micro controller unit (MCU), graphic processing unit (GPU), neural processing unit (NPU), digital signal processor (DSP), application processor (AP), communication processor (CP), or any form of processor well known in the technical field of the present disclosure.

The memory 350 may store data and information generated during the process of generating texture maps. The memory 350 is a volatile memory such as DRAM or SRAM.

The storage device 360 may store untextured meshes for various objects.

The storage device 360 may store the texture map generation model described above.

The storage device 360 may store multiple texture map generation models corresponding to 3D object types.

The storage device 360 may store the generated PBR texture map.

The storage device 360 may store a mesh mapping the generated PBR texture map. That is, the storage device 360 may store a 3D asset DB that stores 3D assets.

The storage device 360 may be implemented as a device such as a hard disk drive, Solid State Drive, USB flash drive, memory card, optical disk, or network-based storage device (Network Attached Storage, cloud storage, etc.).

The display device 370 may output interfaces necessary for texture map generation and texture map mapping processes, PBR texture maps, untextured meshes, textured meshes, etc.

The display device 370 may be implemented as various types of devices.

The display device 370 may be implemented by various display methods such as liquid crystal, plasma, light-emitting diode, organic light-emitting diode, surface-conduction electron-emitter, carbon nano-tube, nano-crystal, etc.

The processor 340 may select a texture map generation model corresponding to a selected mesh from among multiple stored texture map generation models.

The processor 340 calculates a PBR texture map using the trained texture map generation model.

The processor 340 may generate a PBR texture map by inputting randomly sampled noise into the texture map generation model.

The processor 340 may use the fixed noise used in the training process of the corresponding texture map generation model as input.

Furthermore, the processor 340 may generate various PBR texture maps using the same texture map generation model while changing the input noise.

The processor 340 may generate a textured mesh by mapping the generated PBR texture map to the mesh based on UV coordinates.

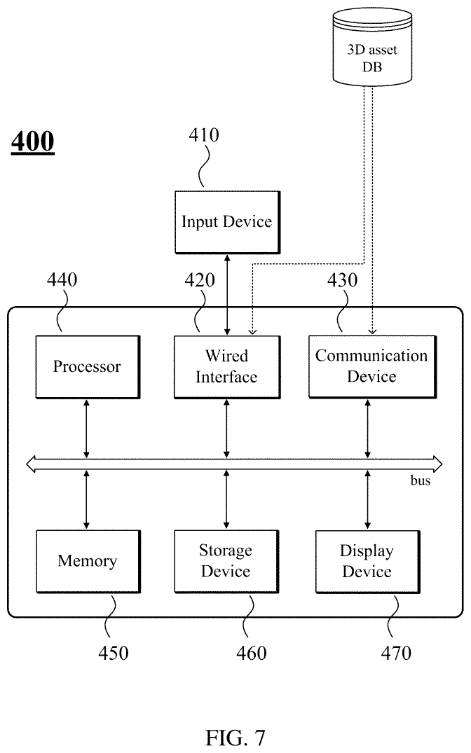

FIG. 7 illustrates an example of a hardware apparatus 400 for generating 3D content. The hardware apparatus 400 is a device that generates 3D content using 3D assets. At this time, the 3D assets are prepared using texture maps generated using the texture map generation model described above. The hardware apparatus 400 may take the form of a computer device, smart device, network server, data processing-dedicated chipset, etc.

The hardware apparatus 400 may include an input device 410, wired interface 420, communication device 430, processor 440, memory 450, and storage device 460.

Alternatively, the hardware apparatus 400 may include an input device 410, wired interface 420, communication device 430, processor 440, memory 450, storage device 460, and display device 470.

Each internal component of the hardware apparatus 400 may be connected by a bus. The bus may use a specific bus depending on the type of connected entity. For example, the bus may be any one of AMBA (AHB/AXI/APB), PCIe, SPI, or MIPI.

The input device 410 is a device that receives user commands or information.

Also, the input device 410 may be a device that receives necessary data from a physically connected external device or storage device.

The input device 410 may receive operations or commands for generating 3D content from the user.

The input device 410 may receive a 3D asset selection command.

The input device 410 may receive 3D assets used for 3D content generation.

The input device 410 may be any of various types of devices. For example, the input device 410 may be at least one of a mouse, keyboard, touch input device, camera, SCSI device, PCI bus-based device, or ATAPI device.

The wired interface 420 is a device component that transfers data transmitted by the input device 410 inside the device. The wired interface 420 may consist of software drivers and hardware.

The wired interface 420 may include a controller corresponding to each input device, a device driver controlling the operation of the controller, and a kernel I/O subsystem that integrally manages input/output control requests of the device driver. The kernel I/O subsystem stores input/output requests from the device driver in a queue and schedules the requests based on request priority or device status.

The wired interface 420 may include interfaces such as PS/2, USB, Ethernet port, HDMI, MIPI CSI, DisplayPort, Thunderbolt, etc.

The wired interface 420 may receive a specific 3D asset from a 3D asset DB. The 3D asset DB may store multiple 3D assets. At this time, the multiple 3D assets were generated using the texture map generation model as described in FIG. 1.

The wired interface 420 may transfer the generated 3D content to other components inside the device or external objects.

The communication device 430 refers to a component that receives and transmits certain information through external wired or wireless networks. The communication device 430 may consist of a circuit including an antenna and a communication module (S/W module, chip, etc.) corresponding to a communication protocol. The communication protocol may be at least one of wired LAN (Ethernet), wireless LAN (IEEE 802.11), mobile communication (LTE, 5G NR, etc.), Bluetooth, NFC, etc.

The communication device 430 may receive operations or commands for generating 3D content.

The communication device 430 may receive 3D assets used for 3D content generation.

The communication device 430 may transmit a specific 3D asset selection command to the 3D asset DB.

The communication device 430 may receive the selected 3D asset from the 3D asset DB.

The communication device 430 may transmit the generated 3D content to external objects.

The processor 440 controls the operation of all components of the hardware apparatus 400.

The processor 440 may perform operations on at least one application or computer program for executing methods/operations according to various embodiments of the present disclosure.

The processor 440 is a general-purpose processor that executes at least part of a control program installed in the storage device 460 or at least part of a program loaded in the memory 450.

The processor 440 may be implemented as circuitry (e.g., processing circuitry) such as a system on chip (SoC) or integrated circuit (IC).

The processor 440 may include one or more processors. For example, the processor 440 may include a combination of one or more processors such as CPU, MPU, MCU, GPU, NPU, DSP, AP, CP, or any form of processor well known in the technical field of the present disclosure.

The memory 450 may store data generated during the 3D content generation process. The memory 450 is a volatile memory such as DRAM or SRAM.

The storage device 460 may store 3D content creation tools. The 3D content creation tool may be any of commercial graphic engines such as Blender, Unity, Unreal Engine, etc.

The storage device 460 may store 3D assets, 3D content, etc.

The storage device 460 may be implemented as a device such as a hard disk drive, Solid State Drive, USB flash drive, memory card, optical disk, or network-based storage device.

The display device 470 may output interface screens for 3D content generation, 3D assets, 3D content, etc.

The display device 470 may be implemented as various types of devices.

The display device 470 may be implemented by various display methods such as liquid crystal, plasma, light-emitting diode, organic light-emitting diode, surface-conduction electron-emitter, carbon nano-tube, nano-crystal, etc.

The processor 440 may obtain textured meshes necessary for 3D content production from the 3D asset DB. At this time, the textured meshes stored in the 3D asset DB are meshes to which PBR texture maps generated using the texture map generation model described above are mapped.

The processor 440 may select a specific textured mesh from the 3D asset DB according to user commands input through the input device 410.

The processor 440 may generate 3D content using one or more selected textured meshes. At this time, the 3D content may be any of game, movie, metaverse, VR/AR content.

The processor 440 may arrange textured meshes and adjust lighting, camera settings, etc. using the 3D content creation tool.

The processor 440 may change the lighting environment of 3D content or adjust material properties by utilizing the characteristics of PBR texture maps. Since PBR texture maps support physically-based rendering, realistic rendering results can be obtained under various lighting conditions.

The processor 440 may control to store the generated 3D content in the storage device 460 or transmit it externally through the communication device 430.

The processor 440 may output the 3D content production process and results in real-time through the display device 470.

The hardware apparatus 400 may provide network-based collaboration functions so that multiple users can collaborate to produce 3D content. In this case, the communication device 430 may transmit and receive data with other user terminals.

Methods according to embodiments described in the specification of the present disclosure may be implemented in the form of hardware, software, or a combination of hardware and software.

Also, the texture map generation model building method, texture map generation method, and textured mesh generation method as described above may be implemented as a program (or application) including executable algorithms that can be executed on a computer. The program may be provided stored on a non-transitory computer-readable medium.

When implemented in software, a computer-readable storage medium storing one or more programs (software modules) may be provided. One or more programs stored in the computer-readable storage medium are configured for execution by one or more processors within an electronic device. One or more programs include instructions that cause the electronic device to execute methods according to embodiments described in the specification of the present disclosure.

The non-transitory computer readable medium refers to a medium that stores data semi-permanently (e.g., the storage device) and is capable of being read by a device, rather than a medium that stores data for a short period of time, such as a register, cache, or memory. Specifically, the various applications or programs described above may be provided by being stored in the non-transitory computer readable medium such as a CD, a DVD, a hard disk, a Blu-ray disk, a USB, a memory card, a read-only memory (ROM), a programmable read only memory (PROM), an erasable PROM (EPROM), an electrically EPROM (EEPROM), or a flash memory.

The transitory computer readable medium refers to various types of RAM such as a static RAM (SRAM), a dynamic RAM (DRAM), a synchronous DRAM (SDRAM), a double data rate SDRAM (DDR SDRAM), an enhanced SDRAM (ESDRAM), a synclink DRAM (SLDRAM), and a direct Rambus RAM (DRRAM).

Various examples and aspects of the present disclosure are described below. These are provided as examples, and do not limit the scope of the present disclosure.

The description herein has been presented to enable any person skilled in the art to make, use and practice the technical features of the present disclosure, and has been provided in the context of one or more particular example applications and their example requirements. Various modifications, additions and substitutions to the described embodiments will be readily apparent to those skilled in the art, and the principles described herein may be applied to other embodiments and applications without departing from the scope of the present disclosure. The description herein and the accompanying drawings provide examples of the technical features of the present disclosure for illustrative purposes. In other words, the disclosed embodiments are intended to illustrate the scope of the technical features of the present disclosure. Thus, the scope of the present disclosure is not limited to the embodiments shown, but is to be accorded the widest scope consistent with the claims. The scope of protection of the present disclosure should be construed based on the following claims, and all technical features within the scope of equivalents thereof should be construed as being included within the scope of the present disclosure.

What is claimed is:

1. A hardware apparatus for generating 3D (dimension) content, comprising:
a storage device configured to store a 3D authoring tool; and
a processor configured to generate 3D content using at least one 3D asset through the 3D authoring tool,
wherein the at least one 3D asset is generated by mapping a PBR (Physically-Based Rendering) texture map to a specific mesh,
wherein the PBR texture map is generated by inputting sampled noise into a texture map generation model, and
wherein the texture map generation model is trained based on SDS (Score-Distillation Sampling) loss, and wherein the SDS loss is calculated by inputting multiple 2D images and a text prompt for the specific mesh into a text-to-image diffusion model during a training process.

2. The hardware apparatus of claim 1, wherein the multiple 2D images are generated through multi-view rasterization of a textured mesh generated by mapping a PBR texture map generated by the texture map generation model during the training process.

3. The hardware apparatus of claim 1, wherein the text-to-image diffusion model is configured to calculate predicted noise to be removed for one of the multiple 2D images to converge to a distribution satisfying the text prompt condition during the training process.

4. The hardware apparatus of claim 3, wherein the SDS loss is determined based on a difference between the predicted noise and noise added to the one image in a diffusion process of the text-to-image diffusion model.

5. The hardware apparatus of claim 1, wherein the SDS loss is calculated based on SDS loss values for all of the multiple 2D images.

6. A method for generating a PBR texture map using a neural network, comprising:
generating, by an image processing apparatus, a PBR (Physically-Based Rendering) texture map for a specific mesh by inputting sampled noise into a pre-trained texture map generation model,
wherein the texture map generation model is trained based on SDS (Score-Distillation Sampling) loss, wherein the SDS loss is calculated by inputting multiple 2D images and a text prompt for the specific mesh into a text-to-image diffusion model during a training process, and
wherein the multiple 2D images are generated through multi-view rasterization of a textured mesh generated by mapping a PBR texture map generated by the texture map generation model during the training process.

7. The method of claim 6, further comprising mapping, by the image processing apparatus, the PBR texture map to the specific mesh.

8. The method of claim 6, wherein the text-to-image diffusion model calculates predicted noise to be removed for one of the multiple 2D images to converge to a distribution satisfying the text prompt condition during the training process.

9. The method of claim 8, wherein the SDS loss is determined based on a difference between the predicted noise and noise added to the one image in a diffusion process of the text-to-image diffusion model.

10. The method of claim 6, wherein the SDS loss is calculated based on SDS loss values for all of the multiple 2D images.

11. The method of claim 6, wherein the sampled noise is the same noise as the noise used in the training process or different noise.

12. A hardware apparatus for generating a textured mesh, comprising:
an input device configured to receive a selection command for a specific mesh;
a storage device configured to store a texture map generation model trained to generate a texture map for the specific mesh; and
a processor configured to generate a PBR (Physically-Based Rendering) texture map for the specific mesh by inputting sampled noise into the texture map generation model and mapping the PBR texture map to the specific mesh,
wherein the texture map generation model is trained based on SDS (Score-Distillation Sampling) loss, and wherein the SDS loss is calculated by inputting multiple 2D images and a text prompt for the specific mesh into a text-to-image diffusion model during a training process, and
wherein the multiple 2D images are generated through multi-view rasterization of a textured mesh generated by mapping a PBR texture map generated by the texture map generation model during the training process.

13. The hardware apparatus of claim 12, wherein the text-to-image diffusion model calculates predicted noise to be removed for one of the multiple 2D images to converge to a distribution satisfying the text prompt condition during the training process.

14. The hardware apparatus of claim 13, wherein the SDS loss is determined based on a difference between the predicted noise and noise added to the one image in a diffusion process of the text-to-image diffusion model.

15. The hardware apparatus of claim 12, wherein the SDS loss is calculated based on SDS loss values for all of the multiple 2D images.
